(19) United States
(12) Patent Application Publication
(10) Pub. No.: US 2005/0034784 A1
(43) Pub. Date: Feb. 17, 2005

(54) Stripper and flail delimber and debarker

(76) Inventor: Charles Tapscott, Scottsville, VA (US)

Correspondence Address: WILLIAMS MULLEN, FOUNTAIN PLAZA THREE, SUITE 200, 721 LAKEFRONT COMMONS, NEWPORT NEWS, VA, 23606, US

(21) Appl. No.: 10/497,478

(22) PCT Filed: Sep. 26, 2002
(86) PCT No.: PCT/US02/31012

Related U.S. Application Data
(60) Provisional application No. 60/325,032, filed on Sep. 26, 2001.

(51) Int. Cl. A01G 23/08; B27M 3/00; A01G 23/095; B27L 1/00; B27L 3/00

(52) U.S. Cl. 144/338; 144/340; 144/343; 144/24.13; 144/4.1; 144/208.1

(57) ABSTRACT

At the site where trees are freshly felled, the disclosed apparatus by means of a boom arm and claw, pulls the merchantable portions of one or more tree stems through a cutting head assembly. The tree stems are topped by a topping saw removing their unmerchantable tops. The merchantable portion of the tree stems fall by gravity into a guide through and are pushed through a flail mechanism which completely removes the smaller supple limbs and remaining bark missed by the cutter head assembly. The merchantable tree stems are then extracted by the boom arm from the flail mechanism and stacked or loaded on a truck to be taken to a lumber mill. Single tree stems of large diameter, multiple smaller diameter tree stems, and tree stems of hardwood or softwood may be processed by the disclosed invention. The freshly felled tree stems are grasped by the boom arm claw and put through the disclosed apparatus without letting go. This yields an efficient and quick processing method. The protection covering of the flail mechanism provides a safer environment for workers and a more efficient debarking and delimbing device which renders a tree stem ready for processing at a lumber mill.

### FIELD OF THE INVENTION

The disclosed invention relates to a mechanical tree delimber and debarker, leaving the tree stem(s) in marketable condition. More specifically, the invention is designed to be used with a conventional knuckle boom loader taking advantage of its ability to draw a tree stem through a cutter head assembly, and then push and extract the tree stem(s) through spinning flails to completely strip the limbs and bark from the tree stems(s).

### DESCRIPTION OF THE RELATED ART

In the timber industry, tree stems are delimbed through a cutter head assembly which, with stripping blades, strip the limbs from the tree stem as it is drawn through the cutter head assembly. Another usual method to delimb is to pass the tree stems, either singularly or several at a time, through a flail delimbing or debarking machine removing most limbs from the tree stem for loading onto trucks and delivery to lumber mills. Examples of fixed cutter head assemblies through which tree stems are drawn to strip protruding branches are disclosed in U.S. Pat. No., 5,887,635; 6,167,926; 4,704,407; 5,823,975; 6,155,317; 6,000,448, and Pub. No. US2002/006288A1. U.S. Pat. No. 5,887,635 discloses a cutter head assembly which is self aligning, a method using a knuckle boom loader to draw a tree stem through the cutter head assembly to strip the protruding branches, and a topping saw for topping the unmerchantable top end of the tree stem. Similarly, U.S. Pat. No. 6,167,926 discloses a self aligning cutter head assembly through which tree stems are drawn. The result of the use of mechanisms disclosed by these patents is a tree stem which still contains numerous smaller branches missed by the stripping blades and bark, which the stripping blades are not able to remove. These mechanisms miss smaller more supple tree branches which slip through the cutting head assembly without being stripped by the cutting blades. This leaves the tree stem necessary for further processing before turning it into lumber.

Other apparatuses using flails, such as chains or cables, to debark and delimb tree stems are currently in use. For example, U.S. Pat. No. 2,713,365 discloses an upper and lower flail cylinder to-which flails are attached and in between which single tree stems are fed. Similarly, U.S. Pat. No. 2,822,837 discloses a debarker using three flail cylinders to which bristles are attached. Two such cylinders are parallel and vertical and the third horizontal positioned above and perpendicular to the other two cylinders. A single tree is fed between the three flail cylinders for processing. Another flail apparatus, disclosed by U.S. Pat. No. 4,640,325, uses a feed mechanism to feed one tree stem between two horizontal and parallel flail drums, one above the other. Other debarkers and delimbers using a flail apparatus which are limited to the processing of a single tree stem at a time are disclosed in U.S. Patent No.'s 4,738,292; 5,193,597; 5,249,613; 4,889,169; 5,349,999; 4,719,950. Other types of flail apparatuses are designed to be used with a skidder which drag a single or a plurality of tree stems through the disclosed apparatuses. For example, refer to U.S. Pat. No.'s 4,787,431; 4,903,744; 4,711,280. Flail apparatuses have also been designed to be used with knuckle boom loaders. For example, U.S. Pat. No. 5,862,846 discloses a delimber and debarker using a flail apparatus of two parallel horizontal flail drums between which multiple tree stems may be passed. Also disclosed is a feed arm for use on the apparatus for feeding the tree stems into the flail mechanism. U.S. Pat. No. 4,711,280 discloses a flail mechanism containing two vertical and parallel flail drums may be fed by a knuckle boom loader. U.S. Application Pub. No. US2002/006880A1 discloses a delimber with a cutting head assembly with a fixed blade lattice and a topping saw, designed to be used with a knuckle boom loader. Another flail apparatus designed to be used with a circle knuckle boom loader so as to cause less stress on the loader mechanisms, as well as to yield other benefits disclosed therein, is disclosed by U.S. application Ser. No. 10/114,013 by this inventor.

Certain limitations and problems arise when using the machines currently in the market and disclosed in the referenced patents. Current systems are useful to handle particular types of tree stems. For instance, a flail delimber may process hardwoods while it may gouge and tear up softer wood. Likewise, a delimber using a cutter head assembly through which the tree stem is drawn, may gouge the tree stem or rip limbs from smaller diameter softer trees, leaving deep holes in the tree stem. There is no current system which may be used for all types of woods of large diameter tree stems and multiple smaller diameter tree stems. The disclosed invention may be used with hardwoods as well as softwoods, single large diameter tree stems, and smaller diameter multiple tree stems.

Moreover, conventional machines do not completely remove the limbs or bark to yield a clean tree stem free of stems and most bark. Thus, the rough processing in the field by conventional machines necessitate further processing to clean the tree stem at the lumber mill. The flail machines tend to rip the larger branches from the tree stem leaving a deep gouge. The cutter head assemblies will cut the larger branches but oft times miss the smaller supple branches which slide through the mechanism.

Thus, there exists in the industry a need for a machine which cuts, as opposed to rips, the large branches from the tree stem, yet thoroughly cleans the smaller branches from the tree stem as well as cleaning the bark from the tree stem. Processing of freshly felled tree stems is best done in the field near the site at which the trees are felled. The debris left from the processing is then used to replace the nutrients in the soil from which the trees were grown and in which future generations of trees will be grown. Thus, a portable machine is preferable.

### SUMMARY OF THE INVENTION

The present invention provides a compact delimbing and debarking device designed to be used with a knuckle boom loader on site where the trees are being felled. The system is designed to cut the large branches with a cutter head assembly as the felled tree stems are drawn through the cutter head assembly by the knuckle boom loader. The tree stem(s), after being topped, is then pushed through and extracted from a flail mechanism which completely removes the smaller supple limbs and remaining bark missed by the cutter head assembly. The result is a tree stem without gouges and without further need of processing before being used as stock at a lumber mill.

It is an object of the invention to provide a system, easily transportable, by conventional means or by mounting on a vehicle, to be used on-site where trees are being felled. The width and other dimensions of the system are designed to comply with current Federal Transportation and Traffic Regulations governing the trailering or transport of such machinery on the public highways.

Another object of the invention is to render a tree stem fit for use as stock at a lumber mill without further processing to remove limbs and bark.

Yet, another object of the invention is to provide a system allowing the processing of larger diameter trees or multiple smaller diameter tree stems in one processing pass. The processing pass is initiated by the grasping of the tree stem(s) by the knuckle boom loader claw, passing it through the system, and loading the processed tree stem(s) onto a truck, or stacking the tree stem(s) for loading later. Throughout the process, the tree stem is never released by the knuckle boom loader. Thus, an efficient process is achieved.

Another object of the invention is to control the ejection of debris, an important safety feature for workers on site. The flail mechanism of the disclosed machine is designed to clean the debris from the trough below the lower horizontal flail drum and eject it in a controlled fashion out of the end of the machine away from the knuckle boom loader.

Yet another object of the invention is to take advantage of the ability of a conventional nuckle boom loader to both pull the tree stem through the cutter head assembly, then push and extract the topped tree stem through the flail drum assembly for complete processing.

Another object of the invention is to allow the complete processing of multiple smaller diameter (up to 8 inches) tree stems in one processing pass.

Yet another object of the invention is to allow the processing of any type of hardwood or softwood without ripping branches from the tree stem causing gouges or leaving smaller supple branches and bark on the processed tree stem.

Other objectives, advantages, advantages, and pertinent features of the present invention will become apparent from the following detailed description, which when taken in conjunction with the drawings attached, discloses several preferred embodiments of the present invention.

### BRIEF DESCRIPTION OF THE DRAWINGS

The invention will be described in detail hereunder with reference to the accompanying drawing figures wherein;

FIG. 1 shows a side cut away view of the disclosed invention, depicting two positions of tree stems during processing;

FIG. 2 shows a cut away side view of the disclosed invention highlighting the motive portion of the machine;

FIG. 3 shows a rear view of a preferred embodiment of the invention;

FIG. 4 shows a cut away side view of the loading ramp and flail mechanism of a preferred embodiment.

FIG. 5 shows a front view of the trough and flail portion of the invention.

### DETAILED DESCRIPTION OF THE INVENTION

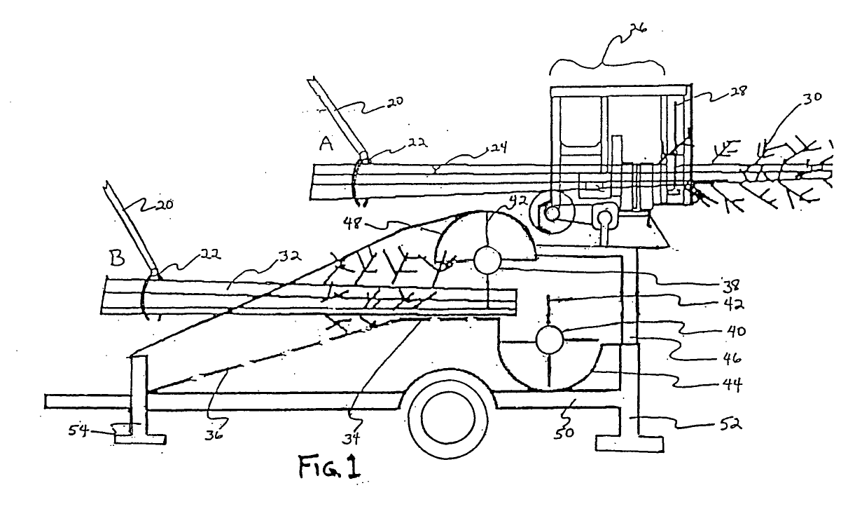

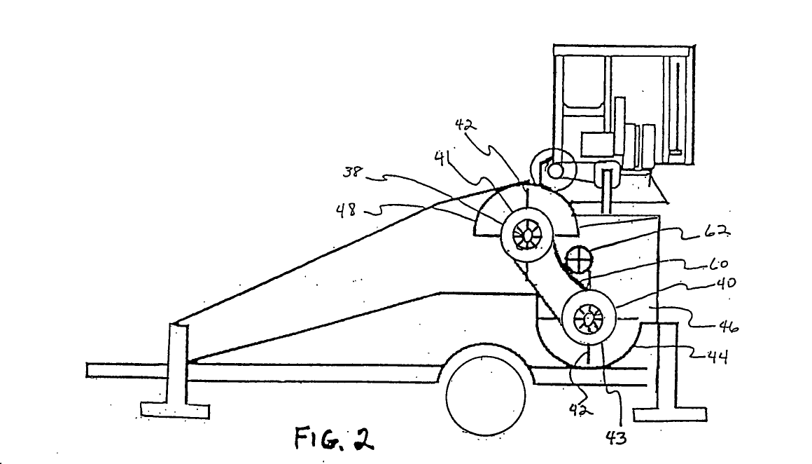

As shown in FIG. 1, the disclosed invention is designed to be used in connection with a knuckle boom loader having a boom arm 20 and claw 22 which is able to grasp, pick up, and move one or a plurality of felled tree stems 24. The felled tree stems are initially processed by the knuckle boom loader drawing the tree stems 24 through the cutter head assembly 26 shown as position A (FIG. 1). The cutter head assembly 26 is well known in the art such as those made and sold by Cutting Systems, Inc. of Union Grove, S.C. Once the marketable portion of the tree stem is drawn through the cutter assembly 26, a topping saw 28 cuts the unmerchantable portion of the top of the tree stems 30. The tree stem 32 is drawn from the cutter head assembly 26 and drops by gravity to the feeder platform 34 or the feeder ramp 36 of the flail assembly (the flail drums 38 and 40 and the flails 42) shown as position B (FIG. 1). The tree stem(s) is pushed through and extracted from the flail drums 38 and 40 so that the remaining branches and bark are removed. The tree stem(s) is withdrawn from the flail assembly by boom arm 20 and placed on a truck or in a pile of processed tree stems for removal to a lumber mill. The cutter head assembly 26 may be any one of a variety of cutter head assemblies currently on the market. The cutter head assembly on the disclosed invention is mounted above the flail assembly so that the boom arm 20 may use gravity to feed the tree stem into the flail assembly below it, after the tree stem is pulled through the cutter head assembly. It should be noted that the preferred embodiment of the flail assembly would be to rotate t he flails 42 in a counter clockwise direction from the vantage point in FIG. 1. This clears debris from the flail assembly trough 44 and ejects it through the opening at the end of the disclosed machine 46. Although FIG. 1 discloses a preferred embodiment mounted on a single axle trailer 50 with outriggers 52 and 54 shown and corresponding outriggers on the other side. The disclosed invention may be mounted on any sort of suitable trailer or vehicle for transport to the site where trees are freshly felled. Also disclosed is a flail assembly cover 48 which prevents debris from the flail assembly from being ejected, endangering workers in the area

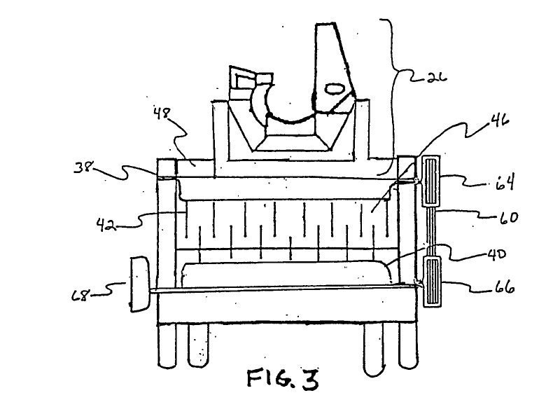

FIG. 2 shows a cutaway view revealing the belt(s) 60 power drives of the flail drums 38 and 40. Rotating power is put to flail drum 40 by hydraulic, internal combustion, or other rotatable motive power. Flail drum 40 is turned in a counter clockwise direction from the vantage point of FIG. 2. Flail drum 40 is fixedly attached to pulley 43 which, by friction, moves belt(s) 60, which in turn engages pulley 41 which is fixedly attached to flail drum 38. Flail drum 38 then rotates in a counter clockwise direction. Tension on belt 60 is adjusted by adjusting pulley 62. All flails 42 being removably attached to the flail drums 38 and 40 are moved in a counter clockwise direction. The action of flails 42 on flail drum 40 serves to clean debris from flail assembly trough 44. Flail assembly cover 48 contains debris preventing uncontrolled ejection of material. Moreover, the counter clockwise rotation of flail drums 38 and 40 with the action of the flails attached, serve to contain debris from being ejected out of the front of the flail assembly by containing it and ejecting it out the ejection opening 46.

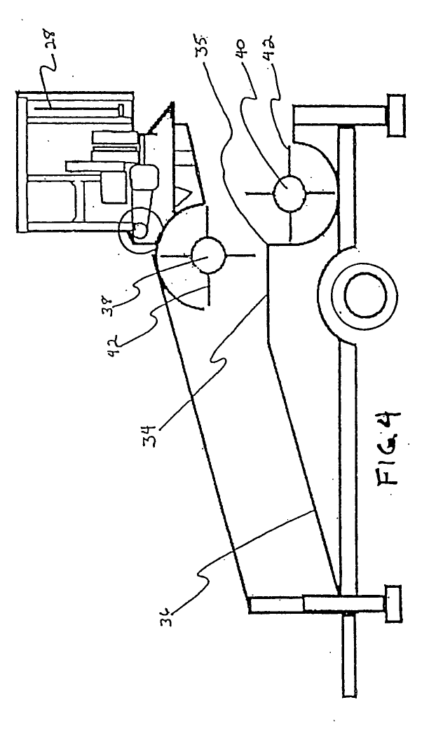

Shown in FIG. 3 is the rear view of the disclosed invention. Note the juxtaposition of the cutter head assembly 26 above the flail mechanism comprising of horizontal and parallel flail drums 38 and 40. Also shown is the upper portion of flail assembly cover 48. Rotatable power from a motive source, such as hydraulic or internal combustion engine, is put to flail drum 40 at power connection 68. Flail drum 40 in turn turns pulley 66 which by friction moves belt(s) 60. Belt(s) 60 in turn moves pulley 64 which, being fixedly attached to flail drum 38, rotates flail drum 38. Portions of flail drums 38 and 40 as well as some flails 42 may be seen inside the disclosed invention through the debris ejection opening 46.

FIG. 4 is a cutaway side view of the disclosed invention. It should be noted that flail drums 38 and 40 are horizontal and parallel. Further, flail drum 38 is positioned above and forwardly offset to lower flail drum 40 so that flails 42 which are removably attached to flail drum 40, do not hit flails 42 which are removably attached to flail drum 38 when flail drums 38 and 40 are in motion. Further shown is a flat portion 34 of the feeder ramp 36. Flat portion 34 is located above the upper most edge of flail drum 40 at edge 35. This positioning allows the tree stem(s) to ride above flail drum 40 as they are pushed between flail drums 38 and 40 by the boom arm 20. The feeder ramp 36 is upwardly inclined and guides the tree stems between flail drums 38 and 40.

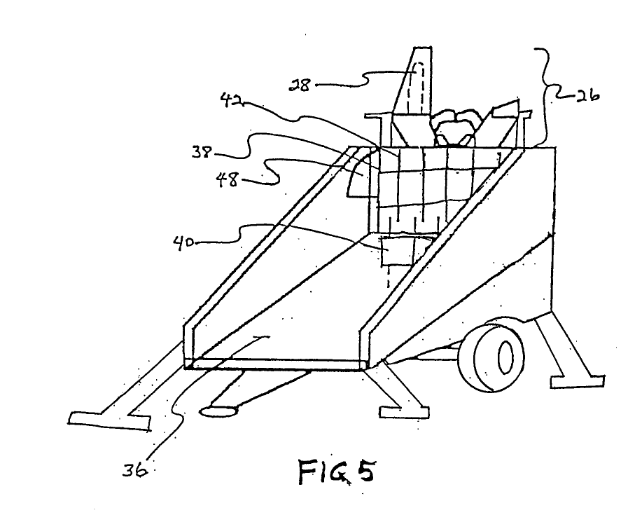

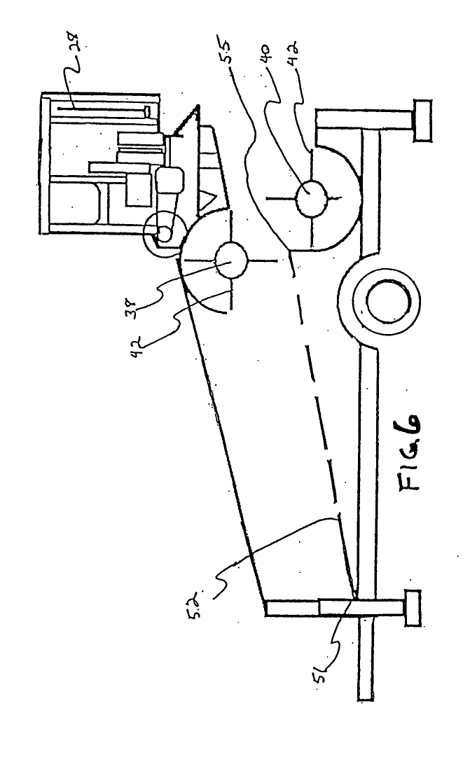

Shown in FIG. 5 is a front view of the disclosed invention. The recently felled tree stems are drawn through the cutter head assembly 26, topped by cutting saw 28, and dropped by gravity onto ramp 36. The disclosed invention shows ramp 36 as flat as opposed to curved, v-shaped, or other trough like shapes. A flat ramp 36 allows multiple tree stem(s) to spread out across the entire length of the flail drums 38 and 40 for more effective feeding between flail drums 38 and 40 and thus more effective cleaning of the tree stems by flails 42. Flail assembly cover 48 is fixedly attached to at least one side of feeder ramp 36, encasing the upper flail drum 38, thus preventing the ejection of stripped materials by the flails 42.

FIG. 6 discloses a cutaway side view of another preferred embodiment. Feeder ramp 52 is inclined upward from lower edge 51 to upper edge 55. Upper edge 55 is positioned level with or above the top of lower flail drum 40. Thus, tree stems are guided by upper edge 55 between flail drums 38 and 40.

1) An apparatus for debarking and delimbing one or a plurality of tree stems comprising:
a cutting head assembly means for initial delimbing tree stems;
a flail means for delimbing and debarking tree stems;
a guide means for guiding tress stems into said flail means;
a power means with drive means for turning said flail means;
a containment means for controlling the ejection of material stripped from the tree stem(s) by said flail means.

2) An apparatus according to claim 1 wherein said cutting head assembly means comprises one of several commercially available cutting head assemblies including a topping saw.

3) An apparatus according to claim 1 wherein said flail means comprises a lower horizontal flail drum, an upper forwardly offset horizontal flail drum, said flail drums being parallel and having a series of removably attached flails extending radially outward from their axis.

4) An apparatus according to claim 3 wherein said flails are chain.

5) An apparatus according to claim 3 wherein said flails are cable.

6) An apparatus according to claim 1 wherein said guide means comprises a feeder ramp coupled to the flail means for directing tree stems into said flail means.

7) An apparatus according to claim 6 wherein said feeder ramp is sloped upward toward the flail means.

8) An apparatus according to claim 6 wherein said feeder ramp is “U” shaped.

9) An apparatus according to claim 6 wherein said feeder ramp is “V” shaped.

10) An apparatus according to claim 6 wherein said feeder ramp is “” shaped.

11) An apparatus according to claim 6 wherein said feeder ramp is attached to a flat feeder portion.

12) An apparatus according to claim 6 wherein said feeder ramp has at least one side.

13) An apparatus according to claim 6 wherein said feeder ramp is upwardly inclined from a lower edge to an upper edge.

14) An apparatus according to claim 1 wherein said power means comprises a hydraulic power system.

15) An apparatus according to claim 1 wherein said power means comprises an internal combustion engine.

16) An apparatus according to claim 1 wherein said drive means comprises a drive chain operatively connected to sprockets which are fixedly attached to the axes of the flail means.

17) An apparatus according to claim 1 wherein said drive means comprises a drive belt operatively attached to pulleys which are fixedly attached to the axes of the flail means.

18) An apparatus according to claim 1 wherein said containment means comprises an enclosure of said flail means having an access opening to allow access of tree stems via the feeder ramp to the flail means.

19) An apparatus according to claim 1 wherein said containment means comprises a flail assembly cover coupled to at least one side of said guide means.

20) A method for delimbing and debarking one or a plurality of tree stems comprising:
felled tree stems are provided;
a knuckle boom loaded with boom arm and claw for grasping one or a plurality of tree stems is also provided;
one or a plurality of tree stems is drawn by the knuckle boom arm through a cutting head assembly;
the tree stems drop by gravity onto a feeder ramp;
the boom arm pushes the tree stems into a flail mechanism;
the boom arm extracts the tree stems from the flail mechanism.

21) An apparatus for debarking and delimbing one or a plurality of tree stems comprising:
a cutting head assembly;
two horizontal parallel flail drums with flails;
a guide ramp to the flails;
a power and drive means for tuning the flail drums;
a containment enclosure with at least one side around the flail drums.
